(19) United States
(12) Patent Application Publication
(10) Pub. No.: US 2015/0341727 A1
(43) Pub. Date: Nov. 26, 2015

(54) ELECTRODYNAMIC ELECTROACOUSTIC TRANSDUCER, DIAPHRAGM THEREOF, AND METHOD OF MANUFACTURING THE SAME

(71) Applicant: KABUSHIKI KAISHA AUDIO-TECHNICA, Tokyo (JP)

(72) Inventor: Hiroshi AKINO, Tokyo (JP)

(21) Appl. No.: 14/704,476

(22) Filed: May 5, 2015

(30) Foreign Application Priority Data
May 20, 2014 (JP) 2014-104387

(51) Int. Cl. H04R 7/16; H04R 31/00; H04R 9/02

(52) U.S. Cl. CPC H04R 7/16; H04R 9/025; H04R 31/00

(57) ABSTRACT

In an electrodynamic electroacoustic transducer, a diaphragm assembly including a diaphragm and a voice coil is attached to a unit housing accurately and easily. A peripheral portion of the diaphragm curves upward while forming a downward convex portion toward an end portion side thereof. In an opening edge portion of the unit housing, a support base portion contacting the downward convex portion of the diaphragm is formed and a concave portion which a peripheral end portion of the diaphragm engages with is formed in an inside surface. In the diaphragm, the downward convex portion is supported by the support base portion of the unit housing in the peripheral portion thereof, so that the peripheral end portion engages with the concave portion of the unit housing in a state in which the peripheral end portion has upward elastic force.

### BACKGROUND OF THE INVENTION

1. Field of the Invention

The present invention relates to an electrodynamic electroacoustic transducer, a diaphragm thereof, and a method of manufacturing the same. More particularly, the present invention relates to an electrodynamic electroacoustic transducer applied to a dynamic headphone or a dynamic microphone, a diaphragm thereof, and a method of manufacturing the same.

2. Description of the Related Art

A dynamic headphone or a dynamic microphone is an electrodynamic electroacoustic transducer that converts an electric signal into a sound wave or converts the sound wave into the electric signal, using the law of electromagnetic induction. FIG. 3 illustrates a cross-sectional view of a dynamic microphone unit. As illustrated in FIG. 3, a microphone unit 50 includes a magnetic circuit in which a disk-shaped pole piece 51 and a magnet 52 to be overlapped are surrounded by a yoke 53. In addition, a gap is formed between the pole piece 51 and the yoke 53. A cylindrical voice coil 55 attached to a diaphragm 54 is arranged in the gap in a vertically movable state.

The yoke 53 is held on an upper portion of a cylindrical unit housing 57. A unit frame 58 having an air chamber provided inside is held on a lower portion of the unit housing 57.

In addition, the diaphragm 54 is covered by a unit cap (resonator) 59 having a plurality of front portion acoustic terminals 59a.

In the microphone unit 50 configured as described above, if the diaphragm 54 is vibrated by the sound wave, the voice coil 55 vibrates vertically at the same time as the vibration of the diaphragm. As a result, electromotive force is generated in the coil and the microphone unit 50 outputs an audio signal based on the sound wave. Such a configuration of the dynamic microphone is disclosed in JP 2013-141189 A, for example.

FIG. 4 is a cross-sectional view of a state before the diaphragm 54, the voice coil 55, and the resonator 59 are attached to the unit housing 57.

Generally, the diaphragm 54 is manufactured by molding a plastic film under heating and pressure. In addition, the voice coil 55 is attached to the diaphragm 54 (referred to as a diaphragm assembly 56) and the diaphragm assembly 56 is attached to the unit housing 57.

Meanwhile, when the diaphragm assembly 56 is attached to the unit housing 57, an outer diameter of the diaphragm 54 needs to be smaller than an inner diameter of the unit housing 57. For this reason, a predetermined gap (about 0.1 to 0.4 mm) is provided in an outer diameter portion of the diaphragm 54 and an inner diameter portion of the unit housing 57.

In addition, in attachment work, an edge portion of the diaphragm is adhered to a peripheral portion of the unit housing 57 using an adhesive material. For this reason, it is necessary to press the edge portion of the diaphragm from the upper side using a weight until the adhesive material is solidified.

However, if the diaphragm is pressed by the weight, distortion occurs in the diaphragm 54. The distortion causes eccentricity at the center of the diaphragm 54 and the center of the unit housing 57. For this reason, the voice coil 55 contacts the magnetic circuit side and accurate mounting of the diaphragm assembly 56 is obstructed.

In the diaphragm pressed by the weight, the weight does not contact the peripheral portion of the diaphragm uniformly. For this reason, the diaphragm 54 and the unit housing 57 are fixed in a state in which stress is applied to the diaphragm 54. In the microphone, the stress lowers frequency response of a low frequency. In the case of the headphone, the stress generates chattering noise.

### SUMMARY OF THE INVENTION

The present invention has been made in view of the above points and an object of the present invention is to provide an electrodynamic electroacoustic transducer in which a diaphragm assembly including a diaphragm and a voice coil is attached to a unit housing accurately and easily, a diaphragm thereof, and a method of manufacturing the same.

According to an aspect of the present invention for solving the above problems, there is provided an electrodynamic electroacoustic transducer that includes a unit housing that houses a magnetic circuit and a diaphragm attached to an opening edge portion of one end of the unit housing, and a voice coil provided at a bottom surface side of the diaphragm. A peripheral portion of the diaphragm curves upward while forming a downward convex portion toward an end portion side thereof. In the opening edge portion of the unit housing, a support base portion contacting the downward convex portion of the diaphragm is formed and a concave portion which a peripheral end portion of the diaphragm engages with is formed in an inside surface. In the diaphragm, the downward convex portion is supported by the support base portion of the unit housing in the peripheral portion thereof, so that the peripheral end portion engages with the concave portion of the unit housing in a state in which the peripheral end portion has upward elastic force.

The concave portion formed in the opening edge portion of the unit housing is preferably an annular concave portion formed along a circumferential direction of the unit housing and an engagement portion formed in the peripheral portion of the diaphragm is preferably the peripheral end portion of the diaphragm.

According to this configuration, the peripheral end portion engages with the concave portion of the unit housing in a state in which the peripheral portion of the diaphragm has the upward elastic force. Therefore, the diaphragm can be fixed firmly to the unit housing. Because distortion and deformation of the diaphragm do not occur, the center of the diaphragm and the center of the unit housing can be automatically aligned with each other and the diaphragm can be attached in a state in which stiffness is stabilized. Because stress by the deformation of the diaphragm does not occur, lowering of low frequency response of a microphone does not occur. In the case in which this configuration is applied to a headphone, occurrence of chattering noise by the stress can be prevented.

In addition, it is not necessary to form a gap to arrange a weight between the diaphragm and the peripheral portion of the unit housing as in the related art. Therefore, an effective area of the diaphragm can be increased as compared with a configuration according to the related art.

The peripheral portion of the diaphragm may be fixed to the opening edge portion of the unit housing by an adhesive material, in a state in which an engagement portion formed in the peripheral portion of the diaphragm engages with the concave portion formed in the opening edge portion of the unit housing.

For example, when the electrodynamic electroacoustic transducer according to the present invention is applied to a dynamic headphone, a diameter of the diaphragm increases, and thus, amplitude also increases. For this reason, it is preferable to fix the diaphragm to the unit housing using the adhesive material, in addition to the engagement of the diaphragm and the unit housing. Even in this case, because the diaphragm is fixed by the engagement with the unit housing, it is not necessary to fix the diaphragm by the weight until the adhesive material is solidified, as in the related art.

Further, according to another aspect of the present invention for solving the above problems, there is provided a diaphragm used in the electrodynamic electroacoustic transducer. The diaphragm is attached to the unit housing.

Further, according to another aspect of the present invention for solving the above problems, there is provided a method of manufacturing an electrodynamic electroacoustic transducer, the method includes providing a unit housing that houses a magnetic circuit and a diaphragm configured to be attached to an opening edge portion of one end of the unit housing; providing a voice coil at a bottom surface side of the diaphragm; curving a peripheral portion of the diaphragm upward while forming a downward convex portion toward an end portion side thereof; forming a concave portion in at least a part of the opening edge portion of the unit housing; forming an engagement portion engaging with the concave portion in the peripheral portion of the diaphragm; and engaging the engagement portion formed in the peripheral portion of the diaphragm with the concave portion formed in the opening edge portion of the unit housing.

According to this method, the peripheral end portion engages with the concave portion of the unit housing in a state in which the peripheral portion of the diaphragm has the upward elastic force. Therefore, the diaphragm can be fixed firmly to the unit housing. As a result, because distortion and deformation of the diaphragm do not occur, the center of the diaphragm and the center of the unit housing can be automatically aligned with each other and the diaphragm can be attached in a state in which stiffness is stabilized. Because stress by the deformation of the diaphragm does not occur, lowering of low frequency response of the microphone does not occur. In the case in which this configuration is applied to a headphone, because stress by the deformation of the diaphragm does not occur, occurrence of chattering noise can be prevented.

Because it is not necessary to form a gap to arrange a weight between the diaphragm and the peripheral portion of the unit housing as in the related art, an effective area of the diaphragm can be increased as compared with a configuration according to the related art.

According to the present invention, an electrodynamic electroacoustic transducer in which a diaphragm assembly including a diaphragm and a voice coil is attached to a unit housing accurately and easily, a diaphragm thereof, and a method of manufacturing the same can be obtained.

### BRIEF DESCRIPTION OF THE DRAWING

FIG. 1 is a cross-sectional view of a dynamic microphone unit to which an electrodynamic electroacoustic transducer according to the present invention is applied;

FIG. 2 is a cross-sectional view illustrating a process for attaching a diaphragm to a unit housing in the dynamic microphone unit of FIG. 1;

FIG. 3 is a cross-sectional view of a dynamic microphone unit according to the related art; and

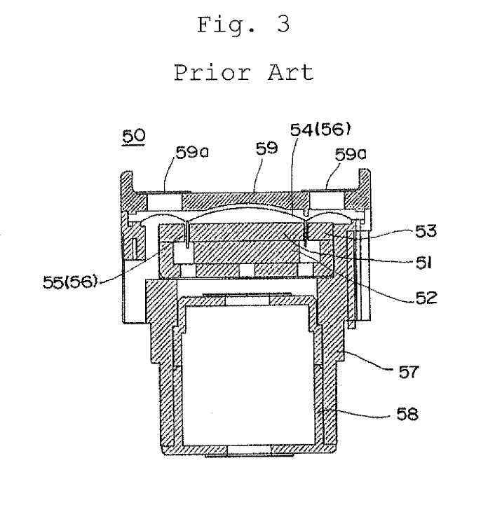

FIG. 4 is a cross-sectional view illustrating a process for attaching a diaphragm to a unit housing in the dynamic microphone unit of FIG. 3.

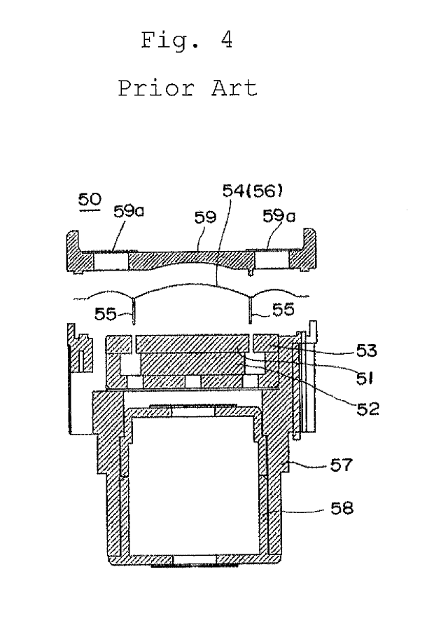

### DESCRIPTION OF THE PREFERRED EMBODIMENTS

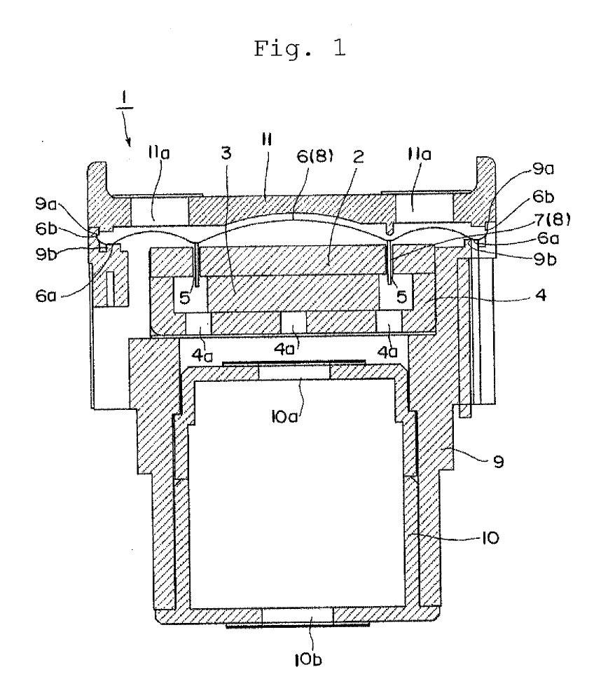

A detailed description will hereinafter be given of an embodiment of the present invention with reference to drawings. In the following embodiment, a dynamic microphone unit will be described as an example of an electrodynamic electroacoustic transducer according to the present invention. FIG. 1 is a cross-sectional view of the dynamic microphone unit to which the electrodynamic electroacoustic transducer according to the present invention is applied.

A dynamic microphone unit 1 of FIG. 1 includes a magnetic circuit. The magnetic circuit is configured by surrounding a bottom portion and side portions of a disk-shaped pole piece 2 and a magnet 3 overlapped to each other by a yoke 4. Predetermined gaps 5 are formed between the pole piece 2 and the yoke 4. In addition, a plurality of sound holes 4a are formed in a bottom surface of the yoke 4.

In addition, a diaphragm 6 made of a plastic film is arranged on the pole piece 2. A cylindrical voice coil 7 is attached to a bottom surface of the diaphragm 6.

A diaphragm assembly 8 is configured by the diaphragm 6 and the voice coil 7.

In addition, the voice coil 7 is arranged to vibrate vertically in the gap 5.

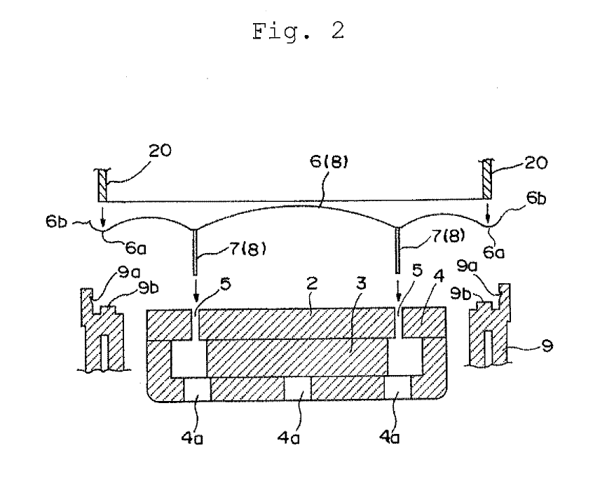

The diaphragm 6 is attached to an opening edge portion of one end side of a cylindrical unit housing 9. Specifically, as illustrated in an exploded view of FIG. 2, a peripheral portion of the diaphragm 6 has a shape in which the peripheral portion curves upward while forming a downward convex portion 6a toward an end portion side thereof. Meanwhile, a support base portion 9b extended in an upward convex shape (rib shape) along an opening is formed in the opening edge portion of one end side of the unit housing 9. In addition, an annular concave portion 9a is formed in an inside surface closer to the outside than the support base portion 9b in the opening edge portion. A peripheral end portion 6b of the diaphragm 6 can engage with the annular concave portion 9a.

Thereby, the downward convex portion 6a of the diaphragm 6 is supported by the support base portion 9b of the unit housing 9 and the peripheral end portion 6b (engagement portion) of the diaphragm 6 engages with the concave portion 9a of the unit housing 9. In addition, the peripheral end portion 6b engages with the concave portion 9a in a state in which the peripheral end portion 6b has elastic force in an upward direction using the downward convex portion 6a as a fulcrum point. For this reason, the diaphragm 6 is fixed firmly to the opening edge portion of the unit housing 9.

In addition, the magnetic circuit including the yoke 4, pole piece 2 and magnet 3 is held on an upper portion of the unit housing 9. The diaphragm 6 is attached to the unit housing 9 to cover the magnetic circuit. In addition, a unit frame 10 having an internal space is fitted into a lower portion of the unit housing 9.

Sound holes 10a and 10b are bored into top and bottom surfaces of the unit frame 10, respectively, to function as rear portion acoustic terminals. In addition, the internal space of the unit frame 10 may function as an air chamber. However, a damper material may be filled into the internal space to enable acoustic resistance to change.

In addition, a disk-shaped unit cap (resonator) 11 is provided to cover the diaphragm 6 attached to the unit housing 9. In the unit cap 11, front portion acoustic terminals 11a including a plurality of sound holes are provided.

Next, a process for attaching the diaphragm 6 to the unit housing 9 in the dynamic microphone unit 1 configured as described above will be described.

First, as illustrated in FIG. 2, the diaphragm 6 is formed such that the peripheral portion thereof curves upward while forming the downward convex portion 6a toward an end portion (peripheral end portion 6b) and is cut.

Meanwhile, in the unit housing 9, the support base portion 9b is formed at the inside of the opening edge portion of one end thereof and an inverted hook-shaped concave portion 9a is formed in an inside surface of the outside thereof. A cut size of the diaphragm 6 is determined such that the peripheral end portion 6b of the diaphragm 6 contacts the concave portion 9a of the unit housing 9.

Next, the downward convex portion 6a provided in the peripheral portion of the diaphragm 6 contacts the support base portion 9b provided in the opening edge portion of the unit housing 9 and the peripheral portion of the diaphragm 6 is pressed using a cylindrical jig 20 as illustrated in FIG. 2. In addition, the peripheral end portion 6b is entered in the concave portion 9a of the unit housing 9 to engage with the concave portion 9a.

According to such an attachment structure, the peripheral end portion 6b engages with the concave portion 9a of the unit housing 9 in a state in which the peripheral portion of the diaphragm 6 has upward elastic force. Therefore, the diaphragm 6 can be fixed firmly to the unit housing 9. As a result, because distortion and deformation of the diaphragm 6 do not occur, the center of the diaphragm 6 and the center of the unit housing 9 can be automatically aligned with each other. Because eccentricity does not occur in the diaphragm 6 and the unit housing 9, the diaphragm 6 can be attached in a state in which stiffness is stabilized. Because stress by the deformation of the diaphragm 6 does not occur, lowering of low frequency response of the microphone does not occur. Similar to the above case, in the case in which this configuration is applied to a headphone, because stress by the deformation of the diaphragm 6 does not occur, occurrence of chattering noise can be prevented.

Because it is not necessary to form a gap to arrange a weight between the diaphragm 6 and the peripheral portion of the unit housing 9 as in the related art, an effective area of the diaphragm 6 can be increased as compared with a configuration according to the related art.

In the embodiment, the diaphragm 6 is attached by only the engagement of the diaphragm 6 and the unit housing 9, without using an adhesive material. However, the electrodynamic electroacoustic transducer according to the present invention is not limited to the embodiment.

For example, when the electrodynamic electroacoustic transducer according to the present invention is applied to a dynamic headphone, a diameter of the diaphragm increases, and thus, amplitude also increases. For this reason, it is preferable to fix the diaphragm to the unit housing using the adhesive material, in addition to the engagement of the diaphragm and the unit housing. Even in this case, because the diaphragm is fixed by the engagement with the unit housing, it is not necessary to fix the diaphragm by the weight until the adhesive material is solidified, as in the related art.

In addition, in the embodiment, the concave portion 9a provided in the opening edge portion of the unit housing 9 is used as an annular concave portion formed in a circumferential direction along an inner circumferential surface. However, a plurality of concave portions may be provided at the same interval along the circumferential direction. In this case, a convex portion capable of engaging with the peripheral end portion of the diaphragm 6 may be formed according to an arrangement of the concave portions of the unit housing 9.

In addition, in the embodiment, the elastic force of the peripheral portion of the diaphragm 6 is changed by an elevation difference of a position of the concave portion 9a in the opening edge portion of the unit housing 9 and a position of the support base portion 9b. According to the change, the stiffness of the diaphragm 6 also changes. For this reason, the low frequency response can be changed by the elevation difference of the concave portion 9a and the support base portion 9b of the unit housing 9.

In addition, in the embodiment, the dynamic microphone unit is described as the example of the electrodynamic electroacoustic transducer according to the present invention. However, the present invention is not limited thereto and can be applied to a dynamic headphone.

In addition, in the embodiment, the unit housing 9 has a cylindrical shape. However, the shape of the unit housing 9 is not limited to the cylindrical shape. That is, the unit housing 9 may be a housing that has an opening capable of attaching the diaphragm and can house the magnetic circuit. For example, the unit housing 9 may have a disk shape adopted in the headphone.

What is claimed is:

1. An electrodynamic electroacoustic transducer comprising:
a unit housing that houses a magnetic circuit;
a diaphragm attached to an opening edge portion of one end of the unit housing; and
a voice coil provided at a bottom surface side of the diaphragm,
wherein a peripheral portion of the diaphragm curves upward while forming a downward convex portion toward an end portion side thereof,
in the opening edge portion of the unit housing, a support base portion contacting the downward convex portion of the diaphragm is formed and a concave portion which a peripheral end portion of the diaphragm engages with is formed in an inside surface, and
in the diaphragm, the downward convex portion is supported by the support base portion of the unit housing in the peripheral portion thereof, so that the peripheral end portion engages with the concave portion of the unit housing in a state in which the peripheral end portion has upward elastic force.

2. The electrodynamic electroacoustic transducer according to claim 1, wherein the concave portion formed in the opening edge portion of the unit housing is an annular concave portion formed along a circumferential direction of the unit housing and an engagement portion formed in the peripheral portion of the diaphragm is the peripheral end portion of the diaphragm.

3. The electrodynamic electroacoustic transducer according to claim 1, wherein the peripheral portion of the diaphragm is adhered to the opening edge portion of the unit housing by an adhesive material and is fixed to the opening edge portion, in a state in which an engagement portion formed in the peripheral portion of the diaphragm engages with the concave portion formed in the opening edge portion of the unit housing.

4. The electrodynamic electroacoustic transducer according to claim 2, wherein the peripheral portion of the diaphragm is adhered to the opening edge portion of the unit housing by an adhesive material and is fixed to the opening edge portion, in a state in which an engagement portion formed in the peripheral portion of the diaphragm engages with the concave portion formed in the opening edge portion of the unit housing.

5. A diaphragm that is used in the electrodynamic electroacoustic transducer according to claim 1,
wherein the diaphragm is attached to the unit housing.

6. A diaphragm that is used in the electrodynamic electroacoustic transducer according to claim 2,
wherein the diaphragm is attached to the unit housing.

7. A diaphragm that is used in the electrodynamic electroacoustic transducer according to claim 3,
wherein the diaphragm is attached to the unit housing.

8. A diaphragm that is used in the electrodynamic electroacoustic transducer according to claim 4,
wherein the diaphragm is attached to the unit housing.

9. A method of manufacturing an electrodynamic electroacoustic transducer comprising:
providing a unit housing that houses a magnetic circuit, and a diaphragm configured to be attached to an opening edge portion of one end of the unit housing;
providing a voice coil at a bottom surface side of the diaphragm;
curving a peripheral portion of the diaphragm upward while forming a downward convex portion toward an end portion side thereof;
forming a concave portion in at least a part of the opening edge portion of the unit housing;
forming an engagement portion engaging with the concave portion in the peripheral portion of the diaphragm; and
engaging the engagement portion formed in the peripheral portion of the diaphragm with the concave portion formed in the opening edge portion of the unit housing.
